(19) United States
(12) Patent Application Publication
(10) Pub. No.: US 2020/0294117 A1
(43) Pub. Date: Sep. 17, 2020

(54) METHOD AND DEVICE FOR FAST ORDER PROCESSING

(71) Applicants: Beijing Jingdong Shangke information Technology Co., Ltd., Beijing (CN); Beijing Jingdong Century Trading Co., Ltd., Beijing (CN)

(72) Inventor: Linjie GAO, Beijing (CN)

(21) Appl. No.: 16/642,312

(22) PCT Filed: Jul. 9, 2018
(86) PCT No.: PCT/CN2018/094977

§ 371 Date: Feb. 26, 2020

(30) Foreign Application Priority Data
Sep. 30, 2017 (CN) 201710929089.3

(51) Int. Cl. G06Q 30/06; G06F 16/955; G06F 16/957; H04L 29/06

(52) U.S. Cl. CPC G06Q 30/0641; H04L 63/08; G06F 16/9574; G06F 16/9554

(57) ABSTRACT

The embodiments of the present application disclose a method and a device for fast order processing. One embodiment of said method comprises: in response to detection of an operation of configuring a shortcut for a commodity, displaying a shortcut configuration page; receiving a configuration parameter inputted by a user into the shortcut configuration page; unloading a shortcut generation request to a server, the shortcut generation request comprising commodity identity information, user identity information, and the configuration parameter; and in response to receipt of a universally unique identifier (UUID) sent by the server corresponding to the shortcut generation request, generating a shortcut comprising the UUID, so that one-click shopping can be realized using the shortcut for an order.

### CROSS-REFERENCE TO RELATED APPLICATIONS

This application claims priority to Chinese Patent Application No. 201710929089.3, filed on Sep. 30, 2017, titled “Method and Apparatus for Fast Processing of Order,” applicants of which are BEIJING JINGDONG SHANGKE INFORMATION TECHNOLOGY CO., LTD and BEIJING JINGDONG CENTURY TRADING CO., LTD. The aforementioned application is hereby incorporated by reference in its entirety.

### TECHNICAL FIELD

The present disclosure relates to the field of computer technology, specifically to the field of Internet technology, and more specifically to a method and apparatus for fast processing of an order.

### BACKGROUND

At present, online shopping is one of the main approaches for people's daily shopping. In order to make online shopping more convenient, in the existing technology, a smart button hardware bound to an e-commerce platform account is provided. After simple setting, automatically buying a commodity by one-key operation can be achieved.

However, this smart button hardware consists of a series of corresponding electronic components, and one button corresponds to only one commodity, thereby occupying the living space.

### SUMMARY

An object of embodiments of the present disclosure is to provide a method and apparatus for fast processing of an order, to solve the problems in the existing technology.

In a first aspect of the present disclosure, a method for fast processing of an order is provided. The method includes presenting a shortcut setting page, in response to detecting an operation of setting a shortcut for a commodity; receiving a configuration parameter inputted by a user into the shortcut setting page; uploading a shortcut generating request to a server, the shortcut generating request including commodity identity information, user identity information, and the configuration parameter; and generating, in response to receiving a universally unique identifier (UUID) corresponding to the shortcut generating request and being sent by the server, a shortcut including the UUID.

In some embodiments, the configuration parameter at least includes commodity parameter information and purchase parameter information.

In some embodiments, after the generating a shortcut including the UUID, the method further includes uploading an order generating request to the server, in response to detecting a user trigger operation on the shortcut.

In some embodiments, the method further includes uploading, in response to receiving order information corresponding to the order generating request and being generated by the server, authentication information inputted by the user to the server.

In some embodiments, after the uploading authentication information inputted by the user to the server, the method further includes receiving authentication result information for indicating whether authentication is successful, the authentication result information being sent by the server.

In some embodiments, the configuration parameter further includes a push permission configuration parameter and/or a timed reminding permission configuration parameter; and the method further includes receiving push information and/or timed reminding information sent by the server based on the push permission configuration parameter and/or the timed reminding permission configuration parameter inputted by the user.

In a second aspect of the present disclosure, an apparatus for fast processing of an order is provided. The apparatus includes a shortcut setting page presenting unit configured to present a shortcut setting page, in response to detecting an operation of setting a shortcut for a commodity; a configuration parameter receiving unit configured to receive a configuration parameter inputted by a user into the shortcut setting page; a shortcut generating request unit configured to upload a shortcut generating request to a server, the shortcut generating request including commodity identity information, user identity information, and the configuration parameter; and a shortcut generating unit configured to generate, in response to receiving a universally unique identifier (UUID) corresponding to the shortcut generating request and being sent by the server, a shortcut including the UUID.

In some embodiments, the configuration parameter at least includes commodity parameter information and purchase parameter information.

In some embodiments, the apparatus further includes: an order generating request unit configured to upload an order generating request to the server, in response to detecting a user trigger operation on the shortcut.

In some embodiments, the apparatus further includes: an authentication information uploading unit configured to upload, in response to receiving order information corresponding to the order generating request and being generated by the server, authentication information inputted by the user to the server.

In some embodiments, the apparatus further includes: an authentication result receiving unit configured to receive authentication result information for indicating whether authentication is successful, the authentication result information being sent by the server.

In some embodiments, the configuration parameter further includes a push permission configuration parameter and/or a timed reminding permission configuration parameter; and the apparatus further includes a pushing unit and/or a reminding unit configured to receive push information and/or timed reminding information sent by the server based on the push permission configuration parameter and/or the timed reminding permission configuration parameter inputted by the user.

In a third aspect of the present disclosure, a terminal is provided, including one or more processors; and a storage apparatus for storing one or more programs, where the one or more programs, when executed by the one or more processors, cause the one or more processors to implement the method for fast processing of an order according to any above method embodiment.

In a fourth aspect of the present disclosure, a computer readable storage medium is provided, storing a computer program thereon, where the program, when executed by a processor, implements the method for fast processing of an order according to any above method embodiment.

The method and apparatus for fast processing of an order provided by embodiments of the present disclosure present a shortcut setting page, in response to detecting an operation of setting a shortcut for a commodity, receive a configuration parameter inputted by a user into the shortcut setting page, then upload a shortcut generating request to a server, and finally receive a universally unique identifier (UUID) corresponding to the shortcut generating request and being sent by the server, and generate a shortcut including the UUID, thereby achieving fast shopping by one-key operation using the shortcut of the order.

### BRIEF DESCRIPTION OF THE DRAWINGS

After reading detailed description of non-limiting embodiments with reference to the following accompanying drawings, other features, objectives and advantages of the present disclosure will become more apparent.

FIG. 1 is a diagram of an example system architecture in which embodiments of the present disclosure may be implemented;

FIG. 2 is a flowchart of a method for fast processing of an order according to an embodiment of the present disclosure;

FIG. 3 is a schematic diagram of an application scenario of the method for fast processing of an order according to an embodiment of the present disclosure;

FIG. 4 is a flowchart of the method for fast processing of an order according to another embodiment of the present disclosure;

FIG. 5 is a schematic structural diagram of an apparatus for fast processing of an order according to an embodiment of the present disclosure;

FIG. 6 is a schematic structural diagram of the apparatus for fast processing of an order according to another embodiment of the present disclosure; and

FIG. 7 is a schematic structural diagram of a terminal device adapted to implement the embodiments of the present disclosure.

### DETAILED DESCRIPTION OF EMBODIMENTS

The present disclosure will be further described in detail below in combination with the accompanying drawings and the embodiments. It should be understood that the specific embodiments described herein are merely used for explaining the relevant disclosure, rather than limiting the disclosure. In addition, it should be further noted that, for the ease of description, only the parts related to the relevant disclosure are shown in the accompanying drawings.

It should be noted that some embodiments in the present disclosure and some features in the disclosure may be combined with each other on a non-conflict basis. The present disclosure will be described in detail below with reference to the accompanying drawings and in combination with the embodiments.

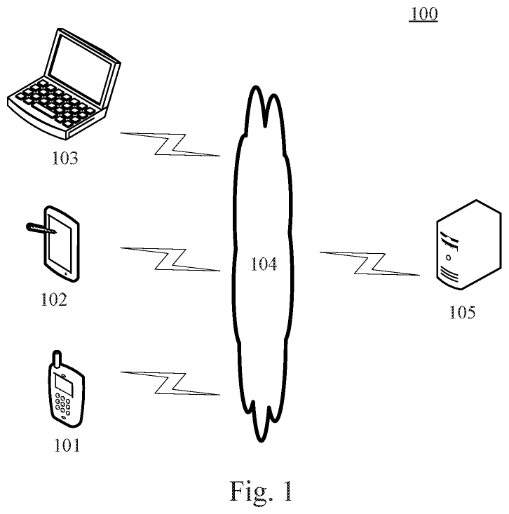

FIG. 1 shows an example system architecture 100 in which a method for fast processing of an order or an apparatus for fast processing of an order of an embodiment of the present disclosure may be implemented.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

A user may interact with the server 105 using the terminal devices 101, 102, and 103 via the network 104, e.g., to receive or send a message. The terminal devices 101, 102, and 103 may be provided with various communication client applications, such as a shopping application, and a web browser application.

The terminal devices 101, 102 and 103 may be various electronic devices having display screens and supporting online shopping, including but not limited to smart phones, tablet computers, laptop portable computers, desktop computers, and the like.

The server 105 may be a server providing various services, such as a back-end application server providing support for the shopping application and the web browsing application on the terminal devices 101, 102, and 103. The back-end application server can process, e.g., analyze, received data such as a request from a shopping website in the shopping application and/or the web browsing application, and return the processing result (e.g., a generated universally unique identifier (UUID), or a generated order) to the terminal devices.

It should be noted that the method for fast processing of an order provided by some embodiments of the present disclosure is generally executed by the terminal devices 101, 102, and 103. Accordingly, the apparatus for fast processing of an order is generally provided in the terminal devices 101, 102, and 103.

It should be understood that the numbers of terminal devices, networks, and servers in FIG. 1 are merely illustrative. Any number of terminal devices, networks, and servers may be provided based on actual requirements.

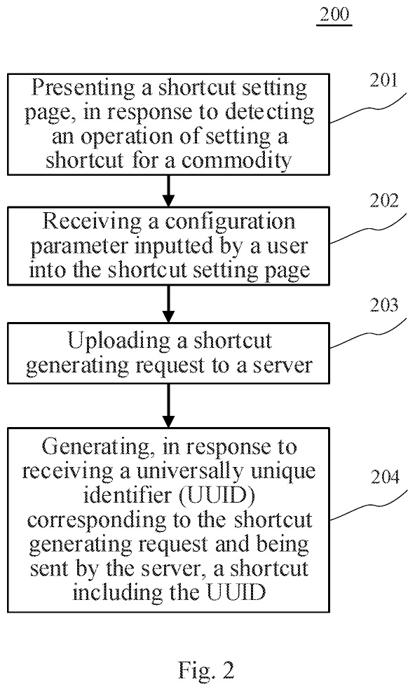

Further referring to FIG. 2, FIG. 2 shows a process 200 of a method for fast processing of an order according to an embodiment of the present disclosure. The method for fast processing of an order includes the following steps:

Step 201: presenting a shortcut setting page, in response to detecting an operation of setting a shortcut for a commodity.

In the present embodiment, when detecting a user operation of setting the shortcut for the commodity, an electronic device (e.g., the terminal device shown in FIG. 1) running the method for fast processing of an order presents the shortcut setting page. For example, when detecting a user operation of setting a shortcut on a commodity details page in a shopping application or a shopping website, the electronic device may present a shortcut setting page corresponding to the commodity. Here, the user operation of setting the shortcut for the commodity may be any operation capable of characterizing awakening a function of setting a shortcut by a user. In practice, an operation of awakening the function of setting a shortcut, e.g., may be a clicking operation on the function, a touching operation on the function, and other operations that are known at present or are to be developed in the future on the function.

Step 202: receiving a configuration parameter inputted by a user into the shortcut setting page.

In the present embodiment, the electronic device (e.g., the terminal device shown in FIG. 1) may receive the configuration parameter inputted by the user into the shortcut setting page obtained based on step 201.

Here, the configuration parameter, for example, may be a commodity-related parameter and/or a parameter related to a user intending to purchase the commodity.

Step 203: uploading a shortcut generating request to a server, the shortcut generating request including commodity identity information, user identity information, and the configuration parameter.

In the present embodiment, the shopping application or the shopping website on the electronic device (e.g., the terminal device shown in FIG. 1) may provide an interactive interface for user login. After the user completes login authentication, the shopping application or the shopping website can acquire the identity information corresponding to the user. In addition, each commodity in the shopping application or the shopping website on the electronic device (e.g., the terminal device shown in FIG. 1) may have one-to-one correspondence with identity information, for distinguishing the commodity from other commodities provided by the shopping application or the shopping website.

The shortcut generating request may be a request capable of characterizing that the electronic device intends to generate a shortcut corresponding to a commodity. The electronic device may upload the request, as well as the commodity identity information, the user identity information, and the configuration parameter included in the request to the server 105.

Step 204: generating, in response to receiving a universally unique identifier (UUID) corresponding to the shortcut generating request and being sent by the server, a shortcut including the UUID.

In the present embodiment, the terminal devices 101, 102, and 103 may upload the above user identity information, commodity identity information, and configuration parameter to the server 105 through step 203. The server 105 may store the received shortcut generating request, as well as the user identity information, the commodity identity information, and the configuration parameter included in the shortcut generating request, and generate the UUID (Universally Unique Identifier) corresponding to the shortcut generating request. Then, the server may send the UUID to the terminal devices 101, 102, and 103. In this way, the terminal devices 101, 102, and 103 can generate the shortcut including the UUID. The universally unique identifier (UUID) generated by the server 105 has one-to-one correspondence with the received and stored shortcut generating request and the user identity information, the commodity identity information, and the configuration parameter included in the shortcut generating request, and plays a role in identifying these pieces of information.

In some alternative implementations of the present embodiment, the received configuration parameter inputted by the user into the shortcut setting page in step 202, for example, may include commodity parameter information and purchase parameter information. In practice, the commodity parameter information generally includes style, color, size, quantity, and the like; and the purchase parameter information generally includes delivery address, delivery time, payment mode, contact information, and the like. In some other alternative implementations, the configuration parameter may further include a push permission configuration parameter and/or a timed reminding permission configuration parameter.

As an example, the electronic device in the present embodiment may describe Action: com.android.launcher.action.INSTALL_SHORTCUT (an action creating a shortcut) in addShortcutIntent (a mechanism describing an operation creating a shortcut). A triggering operation creating the shortcut is specified by Intent.EXTRA_SHORTCUT_INTENT (a component of addShortcutIntent, including triggering operation information). Intent.EXTRA_SHORTCUT_NAME (a component including commodity header information) and Intent.EXTRA_SHORTCUT_ICON (a component including commodity image information) may be provided in the addShortcutIntent respectively. The UUID identifying a shortcut order may be provided in another new actionIntent (e.g., may be a mechanism describing an operation of placing an order) as a parameter, and the actionIntent may be set to execute a series of operations. Finally, creating the shortcut is completed by invoking context.sendBroadcast (a component of addShortcutIntent), thus completing generating an icon corresponding to the commodity on desktop of a mobile phone of the user as a shortcut of the commodity.

When the user clicks the shortcut for placing an order, the system automatically sends preset operation information of placing an order described in the above actionIntent. A corresponding responding module acquires a parameter in the actionIntent, i.e., a UUID of the shortcut order, and makes responsive processing. The responsive processing may include the following actions: First, popping a dialog box for confirming placement of an order, the dialog box presenting brief information of the to-be-placed order. The brief information may include the commodity parameter information, such as style, color, size, quantity, and the like; and may further include the purchase parameter information, such as delivery address, delivery time, payment mode, contact information, and the like. The brief information is requested and obtained by sending the UUID of the shortcut order to the server. The dialog box requires the user to input a preset password for placing an order. If the mobile phone supports fingerprint identification, the user may directly confirm the order placement by fingerprint. If the user confirms the order placement by inputting the password or by fingerprint, then a client application sends the password or fingerprint information to the server for authentication. If the authentication fails, then information prompting authentication failure is fed back. If the authentication is successful, then a corresponding shortcut order interface provided by the server is invoked using the UUID of the shortcut order as a request parameter. The server responds to the request for placing the order, and generates a new order in the system based on shortcut order information found through query based on the UUID. Finally, the server informs the client terminal of successfully placing the order.

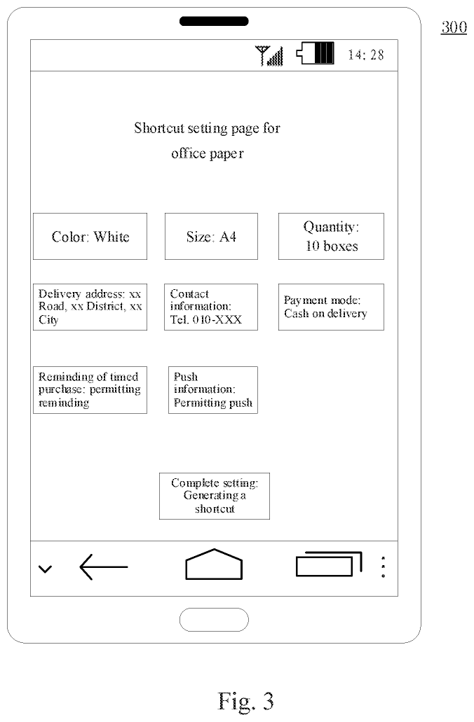

Further referring to FIG. 3, FIG. 3 is a schematic diagram of an application scenario of the method for fast processing of an order according to the present embodiment.

In the application scenario of FIG. 3, a user triggers a function of setting a shortcut on a details page of a commodity, and then an electronic device (e.g., the terminal device shown in FIG. 1) presents a shortcut setting page of the commodity. Then, the shortcut setting page on the electronic device receives a configuration parameter inputted by the user into the page. For instance, in an example of FIG. 3, a current commodity is office paper, then commodity parameter information inputted by the user may be: color: “white,” size: “A4,” quantity: “10 boxes;” purchase parameter information inputted by the user may be: delivery address: “xx Road, xx District, xx City,” payment mode: “cash on delivery,” contact number: “xxx;” and a push permission configuration parameter and/or a timed reminding permission configuration parameter inputted by the user may be: “permitting push” and/or “permitting reminding.” Then, the terminal device uploads user identity information (e.g., personal account number), commodity identity information (e.g., commodity number), and the above configuration parameter to the server (e.g., 105 in FIG. 1). The server generates a corresponding universally unique identifier (UUID). Finally, the electronic device receives the universally unique identifier (UUID) corresponding to the shortcut generating request and being sent by the server, the user clicks “complete setting, generate a shortcut,” and the terminal device generates a shortcut including the UUID.

The above embodiments of the present disclosure provide the method for fast processing of an order, whereby a fast processing mode of the order is generated, such that the user can achieve shopping by one-key operation through the shortcut of the order.

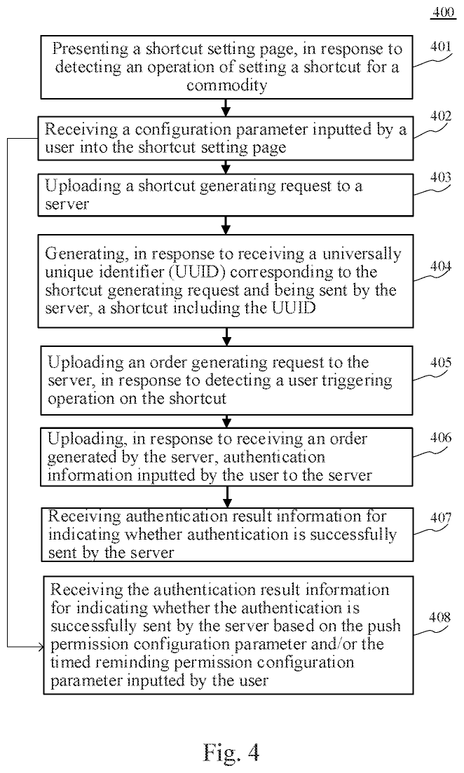

Further referring to FIG. 4, a process 400 of the method for fast processing of an order of another embodiment is shown.

Step 401: presenting a shortcut setting page, in response to detecting an operation of setting a shortcut for a commodity.

In the present embodiment, when detecting a user operation of setting the shortcut for the commodity, an electronic device (e.g., the terminal device shown in FIG. 1) running the method for fast processing of an order presents the shortcut setting page. For example, when detecting a user operation of setting a shortcut on a commodity details page in a shopping application or a shopping website, the electronic device may present a shortcut setting page corresponding to the commodity.

Here, the user operation of setting the shortcut for the commodity may be any operation capable of characterizing awakening by a user a function of setting a shortcut. In practice, an operation of awakening the function of setting a shortcut, e.g., may be selecting the function by clicking, selecting the function by touching, and selecting the function by other approaches that are known at present or are to be developed in the future.

Step 402: receiving a configuration parameter inputted by a user into the shortcut setting page.

In the present embodiment, the electronic device (e.g., the terminal device shown in FIG. 1) may receive the configuration parameter inputted by the user into the shortcut setting page obtained based on step 401.

In some alternative implementations of the present embodiment, the configuration parameter, for example, may include commodity parameter information and purchase parameter information. In some other alternative implementations, the configuration parameter may further include a push permission configuration parameter and/or a timed reminding permission configuration parameter.

Step 403: uploading a shortcut generating request to a server, the shortcut generating request including commodity identity information, user identity information, and the configuration parameter.

In the present embodiment, the shopping application or the shopping website on the electronic device (e.g., the terminal device shown in FIG. 1) may provide an interactive interface for user login. After the user completes login authentication, the shopping application or the shopping website can acquire the identity information corresponding to the user. In addition, each commodity in the shopping application or the shopping website on the electronic device (e.g., the terminal device shown in FIG. 1) may have one-to-one correspondence with identity information, for distinguishing the commodity from other commodities provided by the shopping application or the shopping website.

The shortcut generating request may be a request capable of characterizing that the electronic device intends to generate a shortcut corresponding to a commodity. The electronic device may upload the request, as well as the commodity identity information, the user identity information, and the configuration parameter included in the request to the server 105.

Step 404: generating, in response to receiving a universally unique identifier (UUID) corresponding to the shortcut generating request and being sent by the server, a shortcut including the UUID.

In the present embodiment, the terminal devices 101, 102, and 103 may upload the above user identity information, commodity identity information, and configuration parameter to the server 105 through step 403. The server 105 may store the received shortcut generating request, as well as the user identity information, the commodity identity information, and the configuration parameter included in the shortcut generating request, and generate the UUID (Universally Unique Identifier) corresponding to the shortcut generating request. Then, the server can send the UUID to the terminal devices 101, 102, and 103. In this way, the terminal devices 101, 102, and 103 can generate the shortcut including the UUID. The universally unique identifier (UUID) generated by the server 105 has one-to-one correspondence with the received and stored shortcut generating request and the user identity information, the commodity identity information, and the configuration parameter included in the shortcut generating request, and plays a role in identifying these pieces of information.

Step 405: uploading an order generating request to the server, in response to detecting a user triggering operation on the shortcut.

In the present embodiment, when detecting a user operation of triggering the shortcut obtained based on step 404, the electronic device (e.g., the terminal device shown in FIG. 1) running the method for fast processing of an order uploads the order generating request to the server 105. The terminal device may upload the order generating request to the server 105 by wired connection or wireless connection, where the order generating request includes a universally unique identifier (UUID) corresponding to the shortcut generating request and being obtained based on step 404. The server 105 queries and finds based on the UUID the commodity identity information, the user identity information, and the configuration parameter obtained by uploading in step 403, and generates the order based on the commodity identity information, the user identity information, and the configuration parameter.

Step 406: uploading, in response to receiving an order generated by the server, authentication information inputted by the user to the server.

In the present embodiment, when the electronic device (e.g., the terminal device shown in FIG. 1) running the method for fast processing of an order receives the order obtained based on step 405 and being sent by the server 105, an authentication dialog box for confirming the order pops on a display screen, and after the user inputs authentication information, the authentication information is sent by the terminal devices 101, 102, and 103 to the server 105 for authentication. The authentication information may be a string password (e.g., 725129) or fingerprint.

Step 407: receiving authentication result information for indicating whether authentication is successful, the authentication result information being sent by the server.

In the present embodiment, the terminal device shown in FIG. 1 receives an indication on whether the authentication is successfully sent by the server 105. The indication approach may be a shortcut icon on the terminal device displaying words “successfully placing an order” or “failure in placing an order”, or may be sending a short message to the terminal device, such that the user knows about a state as to whether the order is successfully placed or not.

Step 408: receiving push information and/or timed reminding information sent by the server based on the push permission configuration parameter and/or the timed reminding permission configuration parameter inputted by the user.

In the present embodiment, the terminal device may receive the above push message and/or timed reminding message based on the push permission configuration parameter and/or the timed reminding permission configuration parameter inputted in step 402 in some alternative implementations. As an example, “paper promotion, new product recommendation information” and/or “information of timed reminding of buying office paper,” for instance, may be received. In practice, the user attention may be drawn to the above push information and/or reminding information by a “red dot,” or a short message. The “red dot” refers to a small red dot, a character, and the like displayed on icons of everyday applications, such as a client application.

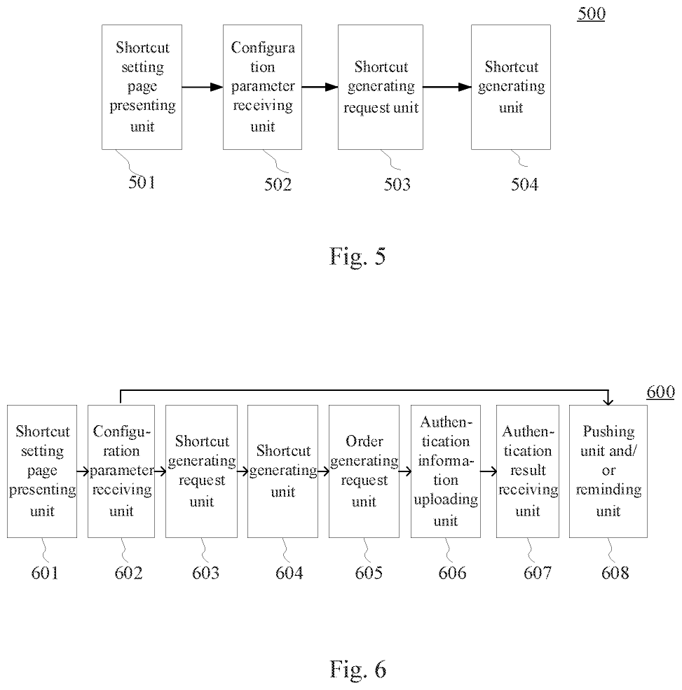

Further referring to FIG. 5, as an implementation of the method shown in the above figures, the present disclosure provides an embodiment 500 of an apparatus for fast processing of an order. The embodiment 500 of the apparatus corresponds to the embodiment 200 of the method shown in FIG. 2, and the apparatus may be specifically applied to various electronic devices (e.g., the terminal device shown in FIG. 1).

As shown in FIG. 5, the apparatus 500 for fast processing of an order of the present embodiment includes: a shortcut setting page presenting unit 501, a configuration parameter receiving unit 502, a shortcut generating request unit 503, and a shortcut generating unit 504.

The shortcut setting page presenting unit 501 is configured to present a shortcut setting page, in response to detecting an operation of setting a shortcut for a commodity.

The configuration parameter receiving unit 502 is configured to receive a configuration parameter inputted by a user into the shortcut setting page; the shortcut generating request unit 503 is configured to upload a shortcut generating request to a server, the shortcut generating request including commodity identity information, user identity information, and the configuration parameter; and the shortcut generating unit 504 is configured to generate, in response to receiving a universally unique identifier (UUID) corresponding to the shortcut generating request and being sent by the server, a shortcut including the UUID. In the present embodiment, the shortcut setting page presenting unit 501 of the apparatus 500 for fast processing of an order may detect a user operation of setting a shortcut on a commodity details page, and then present the shortcut setting page.

In the present embodiment, based on the shortcut setting page obtained by the shortcut setting page presenting unit 501, the above configuration parameter receiving unit 502 may receive the configuration parameter inputted by the user into the shortcut setting page. In some alternative implementations, the above configuration parameter at least includes commodity parameter information and purchase parameter information. In some other alternative implementations, the above configuration parameter further includes a push permission configuration parameter and/or a timed reminding permission configuration parameter.

In the present embodiment, the shopping application or the shopping website on the electronic device (e.g., the terminal device shown in FIG. 1) may provide an interactive interface for user login. After the user completes login authentication, the shopping application or the shopping website can acquire the identity information corresponding to the user. In addition, each commodity in the shopping application or the shopping website on the electronic device (e.g., the terminal device shown in FIG. 1) may have one-to-one correspondence with identity information, for distinguishing the commodity from other commodities provided by the shopping application or the shopping website. The shortcut generating request unit 503 may be a request capable of characterizing that the electronic device intends to generate a shortcut corresponding to a commodity. The electronic device may upload the request, as well as the commodity identity information, the user identity information, and the configuration parameter included in the request to the server 105.

In the present embodiment, the above shortcut generating unit 504 may receive the above universally unique identifier (UUID) playing an identifying role and being sent by the server, and generate a shortcut including the UUID.

Further referring to FIG. 6, a schematic structural diagram of the apparatus for fast processing of an order of another embodiment is shown, and is specifically as follows. The apparatus 600 for fast processing of an order of the present embodiment includes: a shortcut setting page presenting unit 601, a configuration parameter receiving unit 602, a shortcut generating request unit 603, a shortcut generating unit 604, an order generating request unit 605, an authentication information uploading unit 606, an authentication result receiving unit 607, and a pushing unit and/or reminding unit 608.

In the present embodiment, the shortcut setting page presenting unit 601 of the apparatus 600 for fast processing of an order may detect a user operation of setting a shortcut on a commodity details page, and then present a shortcut setting page.

In the present embodiment, based on the shortcut setting page obtained by the shortcut setting page presenting unit 601, the above configuration parameter receiving unit 602 may receive a default parameter inputted by a user into the shortcut setting page. In some alternative implementations, the above configuration parameter at least includes commodity parameter information and purchase parameter information. In some other alternative implementations, the above configuration parameter further includes a push permission configuration parameter and/or a timed reminding permission configuration parameter.

In the present embodiment, the shopping application or the shopping website on the electronic device (e.g., the terminal device shown in FIG. 1) may provide an interactive interface for user login. After the user completes login authentication, the shopping application or the shopping website can acquire the identity information corresponding to the user. In addition, each commodity in the shopping application or the shopping website on the electronic device (e.g., the terminal device shown in FIG. 1) may have one-to-one correspondence with identity information, for distinguishing the commodity from other commodities provided by the shopping application or the shopping website. The shortcut generating request unit 603 may be a request capable of characterizing that the electronic device intends to generate a shortcut corresponding to a commodity. The electronic device may upload the request, as well as the commodity identity information, the user identity information, and the configuration parameter included in the request to the server 105.

In the present embodiment, the above shortcut generating unit 604 may receive the above universally unique identifier (UUID) playing an identifying role and being sent by the server, and generate a shortcut including the UUID. In the present embodiment, after generating the shortcut based on the shortcut generating unit 604, the electronic device (e.g., the terminal device shown in FIG. 1) detects a user operation of triggering the shortcut. The order generating request unit 605 uploads an order generating request to the server, i.e., uploads the universally unique identifier (UUID) included in the shortcut to the server. The server queries and finds the stored user identity information, commodity identity information, and configuration parameter based on the UUID, and generates the order based on the found data information. In the present embodiment, after the apparatus 600 for fast processing of an order receives the order generated by the server, the authentication information uploading unit 606 uploads authentication information inputted by the user to the server. The server authenticates the authentication information, to ensure that an account safely places the order.

In the present embodiment, the authentication result receiving unit 607 receives authentication result information for indicating whether authentication is successfully sent by the server.

In the present embodiment, the pushing unit and/or reminding unit 608 receives push information and/or timed reminding information based on the push permission configuration parameter and/or the timed reminding permission configuration parameter inputted by the configuration parameter receiving unit 602 in some alternative implementations.

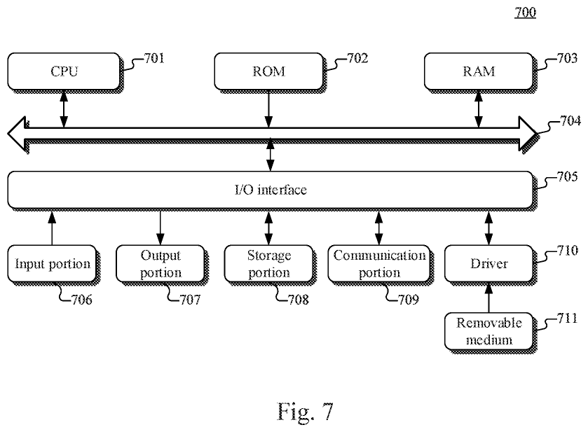

Referring to FIG. 7 below, a schematic structural diagram of a terminal device 700 adapted to implement the embodiments of the present disclosure is shown. The terminal device shown in FIG. 7 is merely an example, and should not pose any limitation on the functions and scope of use of the embodiments of the present disclosure.

As shown in FIG. 7, the terminal device 700 includes a central processing unit (CPU) 701, which may execute various appropriate actions and processes in accordance with a program stored in a read only memory (ROM) 702 or a program loaded into a random access memory (RAM) 703 from a storage portion 708. The RAM 703 may further store various programs and data required by operations of the terminal device 700. The CPU 701, the ROM 702, and the RAM 703 are connected to each other through a bus 704. An input/output (I/O) interface 705 is also connected to the bus 704.

The following components are connected to the I/O interface 705: an input portion 706 including a keyboard, a mouse, or the like; an output portion 707 including a cathode ray tube (CRT), a liquid crystal display device (LCD), a speaker, or the like; a storage portion 708 including a hard disk, or the like; and a communication portion 709 including a network interface card, such as a LAN card and a modem. The communication portion 709 performs communication processing via a network, such as the Internet. A driver 710 is also connected to the I/O interface 705 as required. A removable medium 711, such as a magnetic disk, an optical disk, a magneto-optical disk, and a semiconductor memory, may be installed on the driver 710 as required, such that a computer program read therefrom is installed in the storage portion 708 as needed.

In particular, according to some embodiments of the present disclosure, the process described above with reference to the flow chart may be implemented in a computer software program. For example, some embodiments of the present disclosure include a computer program product, which includes a computer program that is carried in a computer readable medium. The computer program includes program codes for executing the method as shown in the flow chart. In such an embodiment, the computer program may be downloaded and installed from a network via the communication portion 709, and/or may be installed from the removable medium 711. The computer program, when executed by the central processing unit (CPU) 701, implements the above functions defined by the method of the embodiments of the present disclosure. It should be noted that the computer readable medium of the present disclosure may be a computer readable signal medium or a computer readable storage medium or any combination of the above two. An example of the computer readable storage medium may include, but is not limited to: electric, magnetic, optical, electromagnetic, infrared, or semiconductor systems, apparatuses, elements, or a combination of any of the above. A more specific example of the computer readable storage medium may include, but is not limited to: an electrical connection with one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In the present disclosure, the computer readable storage medium may be any tangible medium including or storing programs, which may be used by, or used in combination with, a command execution system, apparatus or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes included on the computer readable medium may be transmitted with any suitable medium, including but not limited to: wireless, wired, optical cable, RF medium, etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logical functions. It should be further noted that, in some alternative implementations, the functions denoted by the blocks may also occur in a sequence different from the sequences shown in the figures. For example, any two blocks presented in succession may be executed substantially in parallel, or sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in some embodiments of the present disclosure may be implemented by software or hardware. The described units may also be provided in a processor, for example, described as: a processor including a shortcut setting page presenting unit, a configuration parameter receiving unit, a shortcut generating request unit, and a shortcut generating unit. The names of the units do not constitute a limitation to such units themselves in some cases.

In another aspect, the present disclosure further provides a computer readable medium. The computer readable medium may be included in the apparatus described in the above embodiments, or a stand-alone computer readable medium without being assembled into the apparatus. The computer readable medium stores one or more programs. The one or more programs, when executed by the apparatus, cause the apparatus to: present a shortcut setting page, in response to detecting an operation of setting a shortcut for a commodity; receive a configuration parameter inputted by a user into the shortcut setting page; upload a shortcut generating request to a server, the shortcut generating request including commodity identity information, user identity information, and the configuration parameter; and generate, in response to receiving a universally unique identifier (UUID) corresponding to the shortcut generating request and being sent by the server, a shortcut including the UUID.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for fast processing of an order, comprising:
presenting a shortcut setting page, in response to detecting an operation of setting a shortcut for a commodity;
receiving a configuration parameter inputted by a user into the shortcut setting page;
uploading a shortcut generating request to a server, the shortcut generating request comprising commodity identity information, user identity information, and the configuration parameter; and
generating, in response to receiving a universally unique identifier (UUID) corresponding to the shortcut generating request and being sent by the server, a shortcut including the UUID.

2. The method according to claim 1, wherein the configuration parameter at least comprises:
commodity parameter information and purchase parameter information.

3. The method according to claim 1, wherein after the generating a shortcut including the UUID, the method further comprises:
uploading an order generating request to the server, in response to detecting a user trigger operation on the shortcut.

4. The method according to claim 3, wherein the method further comprises:
uploading, in response to receiving order information corresponding to the order generating request and being generated by the server, authentication information inputted by the user to the server.

5. The method according to claim 4, wherein after the uploading authentication information inputted by the user to the server, the method further comprises:
receiving authentication result information for indicating whether authentication is successful, the authentication result information being sent by the server.

6. The method according to claim 2, wherein the configuration parameter further comprises a push permission configuration parameter and/or a timed reminding permission configuration parameter; and
the method further comprises:
receiving push information and/or timed reminding information sent by the server based on the push permission configuration parameter and/or the timed reminding permission configuration parameter inputted by the user.

7. An apparatus for fast processing of an order, comprising:
at least one processor; and
a memory storing instructions, wherein the instructions when executed by the at least one processor, cause the at least one processor to perform operations, the operations comprising:
presenting a shortcut setting page, in response to detecting an operation of setting a shortcut for a commodity;
receiving a configuration parameter inputted by a user into the shortcut setting page;
uploading a shortcut generating request to a server, the shortcut generating request comprising commodity identity information, user identity information, and the configuration parameter; and
generating, in response to receiving a universally unique identifier (UUID) corresponding to the shortcut generating request and being sent by the server, a shortcut including the UUID.

8. The apparatus according to claim 7, wherein the configuration parameter at least comprises commodity parameter information and purchase parameter information.

9. The apparatus according to claim 7, wherein the operations further comprises:
uploading an order generating request to the server, in response to detecting a user trigger operation on the shortcut.

10. The apparatus according to claim 8, wherein the operations further comprises:
uploading, in response to receiving order information corresponding to the order generating request and being generated by the server, authentication information inputted by the user to the server.

11. The apparatus according to claim 9, wherein the operations further comprises:
receiving authentication result information for indicating whether authentication is successful, the authentication result information being sent by the server.

12. The apparatus according to claim 8, wherein the configuration parameter further comprises a push permission configuration parameter and/or a timed reminding permission configuration parameter; and
the operations further comprises:
receiving push information and/or timed reminding information sent by the server based on the push permission configuration parameter and/or the timed reminding permission configuration parameter inputted by the user.

13. (canceled)

14. A non-transitory computer readable storage medium, storing a computer program thereon, wherein the program, when executed by a processor, causes the processor to perform operations, the operations comprising:
presenting a shortcut setting page, in response to detecting an operation of setting a shortcut for a commodity;
receiving a configuration parameter inputted by a user into the shortcut setting page;
uploading a shortcut generating request to a server, the shortcut generating request comprising commodity identity information, user identity information, and the configuration parameter; and
generating, in response to receiving a universally unique identifier (UUID) corresponding to the shortcut generating request and being sent by the server, a shortcut including the UUID.

15. The storage medium according to claim 14, wherein the configuration parameter at least comprises:
commodity parameter information and purchase parameter information.

16. The storage medium according to claim 14, wherein after the generating a shortcut including the UUID, the operations further comprise:
uploading an order generating request to the server, in response to detecting a user trigger operation on the shortcut.

17. The storage medium according to claim 16, wherein the operations further comprise:
uploading, in response to receiving order information corresponding to the order generating request and being generated by the server, authentication information inputted by the user to the server.

18. The storage medium according to claim 17, wherein after the uploading authentication information inputted by the user to the server, the operations further comprise:
receiving authentication result information for indicating whether authentication is successful, the authentication result information being sent by the server.

19. The storage medium according to claim 15, wherein the configuration parameter further comprises a push permission configuration parameter and/or a timed reminding permission configuration parameter; and
the operations further comprise:
receiving push information and/or timed reminding information sent by the server based on the push permission configuration parameter and/or the timed reminding permission configuration parameter inputted by the user.
